(19) United States
(12) Patent Application Publication
(10) Pub. No.: US 2022/0329732 A1
(43) Pub. Date: Oct. 13, 2022

(54) IMAGING APPARATUS, SOUND PROCESSING METHOD, AND PROGRAM

(71) Applicant: SONY GROUP CORPORATION, TOKYO (JP)

(72) Inventor: NORIYUKI SETOJIMA, TOKYO (JP)

(21) Appl. No.: 17/753,958

(22) PCT Filed: Sep. 9, 2020
(86) PCT No.: PCT/JP2020/034176

§ 371 Date: Mar. 18, 2022

(30) Foreign Application Priority Data
Sep. 30, 2019 (JP) 2019-179413

(51) Int. Cl. H04N 5/232; H04N 5/60

(52) U.S. Cl. CPC H04N 5/23245; H04N 5/607; H04N 5/23225

(57) ABSTRACT

There is provided an imaging apparatus including: a sound processing unit that performs processing with respect to a sound signal input through a microphone; and a control unit that separately controls a parameter related to processing of the sound signal at a time of recording of a captured image when the sound data processed by the sound processing unit is recorded together with image data obtained by imaging through an imaging unit and a time of recording a sound memo when the sound data processed by the sound processing unit is recorded as the sound memo.

### CROSS REFERENCE TO RELATED APPLICATIONS

This application claims the benefit of Japanese Priority Patent Application JP 2019-179413 filed Sep. 30, 2019, the entire contents of which are incorporated herein by reference.

### TECHNICAL FIELD

The present technology relates to an imaging apparatus, a sound processing method, and a program and, in particular, to a processing technology related to sound data in the imaging apparatus.

### BACKGROUND ART

Users such as professional photographers and reporters who use imaging apparatuses (also called “cameras”) for work purposes upload images captured by the imaging apparatuses to the servers (for example, file transfer protocol (FTP) servers) of newspaper publishing companies or the like by using the communication functions of the imaging apparatuses in imaging scenes. Patent Literature 1 has disclosed a technology related to upload of an image or the like. Further, Patent Literature 2 has disclosed addition of a sound memo to an image.

### CITATION LIST

### Patent Literature

### [PTL 1]

Japanese Patent Application Laid-open No. 2018-093325

### [PTL 2]

Japanese Patent Application Laid-open No. 2005-293339

### SUMMARY

### Technical Problem

By the way, in a situation where an image captured by such a professional photographer or the like is uploaded to a server of a newspaper publishing company or the like, it is desirable to add an explanation and the like to the image. As one of possible methods therefor, the user inputs sound for explanation of the image and the input sound is associated with the image data as a sound memo, for example.

By the way, sound is also often recorded in a case of recording a moving image. For recording the sound, microphones are incorporated in or connected to the imaging apparatus and a sound signal processing circuit system is also provided in the imaging apparatus. Therefore, the microphones or the sound signal processing circuit system can be utilized for recording the sound memo. However, the sound in recording the moving image and the sound memo have different purposes, and the quality and the like necessary for the sound data are also different between the sound in recording the moving image and the sound memo. Therefore, there is a possibility that sufficient quality cannot be maintained in practice in a case where the microphones or the like are commonly used.

In view of this, the present disclosure proposes a technology that enables an imaging apparatus to provide suitable sound data even in a case where microphones or the like are commonly used at the time of recording a captured image and at the time of recording a sound memo.

### Solution to Problem

In accordance with the present technology, there is provided an imaging apparatus including: a sound processing unit that performs processing with respect to a sound signal input through a microphone; and a control unit that separately controls a parameter related to processing of the sound signal at a time of recording of a captured image when sound data processed by the sound processing unit is recorded together with image data obtained by imaging through an imaging unit and a time of recording a sound memo when the sound data processed by the sound processing unit is recorded as the sound memo.

For example, the microphone for recording a surrounding sound when the moving image is captured is commonly used also for recording the sound memo. In this case, a sound processing parameter is set to be changed at the time of recording the captured image and the time of recording the sound memo.

In this case, for example, the control unit may perform control such that the parameter related to the processing of the sound signal is different at the time of recording the captured image and the time of recording the sound memo.

In the above-mentioned imaging apparatus, the control unit may perform switching control of the parameter in a manner that depends on whether record of the sound data to be started is sound record at the time of recording the captured image or sound record at the time of recording the sound memo when starting record of the sound data.

When a situation where sound collected by the microphone is recorded occurs, the parameter is switched in a manner that depends on whether it is the time of recording the captured image or the time of recording the sound memo.

In the above-mentioned imaging apparatus, the control unit may perform switching control of the parameter in a manner that depends on switching of an operation mode.

The operation mode is a moving image-recording mode, a still image-recording mode, a reproduction mode, or the like, for example. The parameter is switched in accordance with switching of such a mode.

In the above-mentioned imaging apparatus, the parameter may include a parameter to perform setting related to gain processing at the sound processing unit.

For example, the parameter is a parameter to set an automatic gain control (AGC) property of the sound processing unit, a parameter to designate a fixed input gain, or the like. Then, for example, in a case where the sound processing unit performs AGC processing, the parameter to set that AGC property is set to be switched in a manner that whether it is the time of recording the captured image or the time of recording the sound memo.

In the above-mentioned imaging apparatus, the parameter may include a parameter to set a frequency property given to the sound data by the sound processing unit.

In a case where the sound processing unit performs filtering processing or equalizing processing, the parameter to set that frequency property is set to be switched in a manner that depends on whether it is the time of recording the captured image or the time of recording the sound memo.

In the above-mentioned imaging apparatus, the parameter may include a parameter to set directivity of the microphone.

That is, the directivity of the microphone is set to be switched in a manner that depends on whether it is the time of recording the captured image or the time of recording the sound memo switching.

In the above-mentioned imaging apparatus, the parameter may include a parameter related to processing to make a change in the amount of data of the sound data.

That is, the amount of data of the sound data is set to be different at the time of recording the captured image and the time of recording the sound memo.

In the above-mentioned imaging apparatus, the sound memo may include sound data associated with one piece of still image data.

The sound memo is sound data obtained by the user inputting explanation or notes related to the still image data as a voice, for example, and is associated with the one piece of still image data.

In the above-mentioned imaging apparatus, the sound data input through the microphone and processed by the sound processing unit in a state in which one piece of still image data is specified is used as the sound memo associated with the specified still image data.

For example, by using the sound data input in the state in which the one piece of still image data is specified as the sound memo, the one piece of still image data and the sound memo are associated with each other.

In the above-mentioned imaging apparatus, the sound memo may include sound data associated with one piece of still image data and be recorded in a sound file different from an image file containing the still image data.

For example, in the state in which the still image data is recorded as the image file and the sound data of the sound memo is recorded as the sound file, that sound memo is managed in association with the still image data.

In the above-mentioned imaging apparatus, the time of recording the captured image may be the time of recording a moving image, and the sound data processed by the sound processing unit may be recorded as a moving image sound synchronized with moving image data.

That is, the parameter related to the sound processing is set to be different at the time of recording the moving image and at the time of recording the sound memo.

The above-mentioned imaging apparatus may further include the microphone.

The microphone incorporated in the imaging apparatus is commonly used for sound collection at the time of recording the captured image and sound collection at the time of recording the sound memo.

In the above-mentioned imaging apparatus, sound collection of a plurality of channels may be performed through the microphone, and display of a microphone input level may be performed for each channel.

A plurality of microphones is incorporated in or connected to the imaging apparatus or stereo microphones that perform sound collection of L and R channels. In this case, display of the microphone input level is performed for each channel.

Further, the microphone may include a microphone to be used in sound collection for obtaining the sound data both at the time of recording the captured image and the time of recording the sound memo.

That is, a common microphone is used as the microphone that collects sound at the time of recording the captured image and the microphone that collects sound at the time of recording the sound memo.

In accordance with the present technology, there is provided a sound processing method including separately controlling a parameter related to processing of a sound signal at a time of recording a captured image when sound data processed by a sound processing unit that performs processing with respect to the sound signal input through a microphone is recorded together with image data obtained by imaging through an imaging unit and a time of recording a sound memo when the sound data processed by the sound processing unit is recorded as the sound memo. Accordingly, regarding sound input through the microphone, sound processing suitable at each of the time of recording the captured image and the time of recording the sound memo can be performed.

In accordance with the present technology, there is provided a program that causes an arithmetic processing apparatus to execute such a sound processing method. For example, the program causes the arithmetic processing apparatus that is the control unit to be incorporated in the imaging apparatus to execute such a sound processing method. Accordingly, various imaging apparatuses can execute the processing of the present technology.

### BRIEF DESCRIPTION OF DRAWINGS

FIG. 1 is a view describing the upload of an image file and a sound file according to an embodiment of the present technology.

FIG. 2 is a view describing an outer appearance of an imaging apparatus according to the embodiment.

FIG. 3 is a view describing a back side of the imaging apparatus according to the embodiment.

FIG. 4 is a block diagram of the imaging apparatus in the embodiment.

FIG. 5 is a view describing an image list screen according to the embodiment FIG. 6 is a view describing an image-group pre-development display screen according to the embodiment.

FIG. 7 is a view describing an image-group post-development display screen according to the embodiment.

FIG. 8 is a view describing the image-group post-development display screen according to the embodiment.

FIG. 9 is a view describing a sound memo recording screen according to the embodiment.

FIG. 10 is a view describing the image-group post-development display screen according to the embodiment.

FIG. 11 is a view describing the image-group pre-development display screen according to the embodiment.

FIG. 12 is a view describing the image-group pre-development display screen according to the embodiment.

FIG. 13 is a view describing a sound memo reproduction screen according to the embodiment.

FIG. 14 is a view describing a deletion-target selection screen according to the embodiment.

FIG. 15 is a view describing a deletion-in-process screen according to the embodiment.

FIG. 16 is a view describing a deletion completion screen according to the embodiment.

FIG. 17 is a view describing a deletion selection screen according to the embodiment.

FIG. 18 is a view describing the deletion selection screen according to the embodiment.

FIG. 19 is a flowchart of assignable button operation detection processing according to the embodiment.

FIG. 20 is a flowchart of microphone preparation processing according to the embodiment.

FIG. 21 is a view describing switching of an AGC property according to the embodiment.

FIG. 22 is a view describing switching of a frequency property according to the embodiment.

FIG. 23 is a view describing switching of a directivity property according to the embodiment.

FIG. 24 is a flowchart of another example of microphone preparation processing according to the embodiment.

### DESCRIPTION OF EMBODIMENTS

Hereinafter, an embodiment will be described in the following order.

<1. Image Upload by Imaging Apparatus>

<2. Configuration of Imaging Apparatus>

<3. Sound Memo Related to Sequentially Shot Images>

<4. Processing Related to Microphone Sound>

<5. Summary and Modified Examples>

### 1. Image Upload by Imaging Apparatus

An imaging apparatus 1 according to an embodiment is capable of uploading a captured image to an external server. First, this image upload will be described.

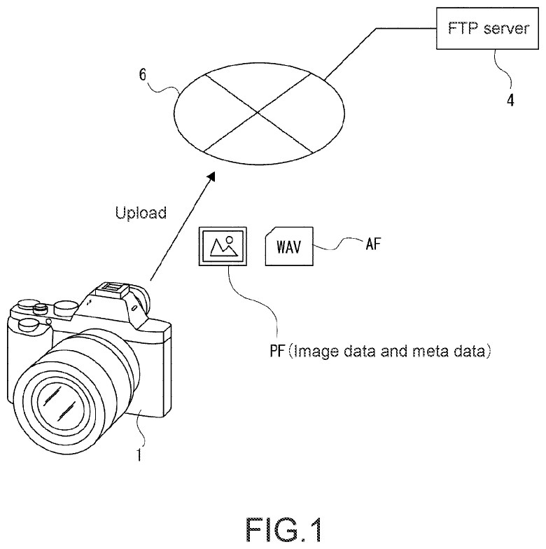

In FIG. 1, the imaging apparatus 1, a FTP server 4, and a network 6 are shown.

The imaging apparatus 1 includes imaging apparatuses in various forms such as video cameras and still cameras. As the imaging apparatus 1 shown in the figure, a camera used by a photographer or a reporter in sites, covering scenes, or the like of sports or events is assumed. For example, one photographer may use one imaging apparatus 1 or a plurality of imaging apparatuses 1 according to circumstances.

Note that the imaging apparatus 1 will be sometimes called a “camera” in the description.

As the network 6, any of the Internet, a home network, a local area network (LAN), a satellite communication network, and various other networks is, for example, assumed.

As the FTP server 4, a server managed by a newspaper publishing company, a broadcasting station, a news agency, or the like is, for example, assumed. Of course, the FTP server 4 is not limited to such a server.

As the form of the FTP server 4, a cloud server, a home server, a personal computer, or the like is assumed.

The imaging apparatus 1 is capable of uploading captured image data or the like to the FTP server 4 via the network 6.

For example, when a user using the imaging apparatus 1 is a professional photographer who works for a newspaper publishing company, he/she is assumed to use a system to immediately upload an image captured at an event site from the imaging apparatus 1 to the FTP server 4. On this occasion, FTP setting information for performing an upload to the FTP server 4 is registered in the imaging apparatus 1. The contents of the FTP setting information include the host name of the FTP server 4, a storage destination path, a user name, a password, a connection type, or the like.

The user can register the FTP setting information in the imaging apparatus 1 by inputting the contents of the FTP setting information through an operation of the imaging apparatus 1 or inputting the contents of the FTP setting information transferred from an external apparatus, for example.

In the embodiment, a situation in which the image file PF and the sound file AF are uploaded and transmitted from the imaging apparatus 1 to the FTP server 4 is assumed.

The imaging apparatus 1 generates image data that is a still image or a moving image and generates metadata that is additional information in accordance with an imaging operation. It is assumed that the image file PF shown in FIG. 1 is a data file containing those image data and metadata.

Further, in this embodiment, the imaging apparatus 1 is equipped with a sound memo function. The sound memo function is a function with which the user is allowed to add sound comments, sound descriptions, or the like to a captured image. For example, when the user produces a sound while performing a prescribed operation with a specific image designated or when a photographer produces a sound to describe image content while performing a prescribed operation at the time of capturing a still image, the sound is recorded and used as a sound memo associated with image data.

It is assumed that the sound file AF shown in FIG. 1 is a data file containing sound data that is such sound memo.

Note that although a surrounding sound is also recorded as sound track data at the time of capturing a moving image, the sound track data is sound data contained in the image file PF and different from the sound file AF. The descriptive sound file AF refers to a file containing sound data as a sound memo.

The following description assumes an example in which a still image is captured, the image file PF contains still image data and metadata, and the sound file AF contains sound memo data generated as the still image is captured.

Note that all the sound files AF are not associated with all image files PF. The imaging apparatus 1 generates the sound file AF and the generated sound file AF is associated with the image file PF only in a case where a photographer or the like performs sound input by using the sound memo function.

Therefore, the image file PF and the sound file AF are transmitted as a pair or only the image file PF is transmitted when the imaging apparatus 1 uploads such files to the FTP server 4.

### 2. Configuration of Imaging Apparatus

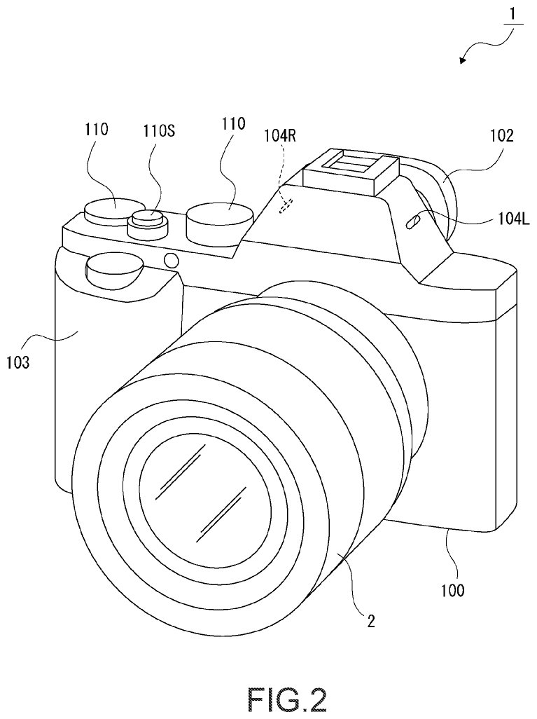

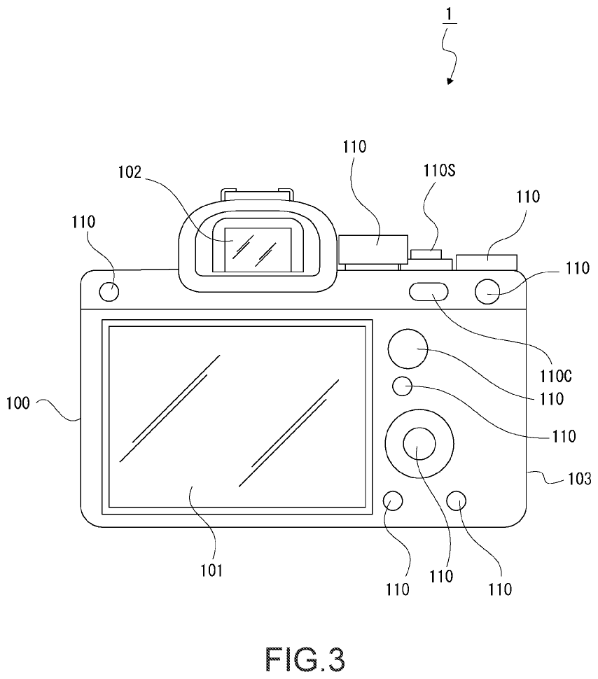

FIG. 2 is a perspective view of the imaging apparatus 1 according to the embodiment as seen from its front side. FIG. 3 is a back view of the imaging apparatus 1. Here, it is assumed that the imaging apparatus 1 is so-called a digital still camera and capable of capturing both a still image and a moving image through the switching of an imaging mode. Further, for capturing a still image, there are a “single shooting mode” on which a single still image is captured by every single release operation and a “continuous shooting mode” on which a plurality of still images is sequentially captured by a release operation.

Note that in the embodiment, the imaging apparatus 1 is not limited to a digital still camera but may be a video camera that is mainly used for capturing a moving image and is also capable of capturing a still image.

In the imaging apparatus 1, a lens barrel 2 is arranged or detachable on the front side of a body housing 100 constituting a camera body.

On the back side (photographer side) of the imaging apparatus 1, a display panel 101 formed by a display device such as a liquid crystal display (LCD) and an organic electro-luminescence (EL) display is, for example, provided.

Further, a display unit formed by a LCD, an organic EL display, or the like is also provided as a viewfinder 102. Further, the viewfinder 102 is not limited to an electronic viewfinder (EVF) but may be an optical viewfinder (OVF).

The user is allowed to visually recognize an image or various information through the display panel 101 or the viewfinder 102.

In this example, both the display panel 101 and the viewfinder 102 are provided in the imaging apparatus 1. However, the imaging apparatus 1 may have a configuration in which one of the display panel 101 and the viewfinder 102 is provided or have a configuration in which both or one of the display panel 101 and the viewfinder 102 is detachable.

On the body housing 100 of the imaging apparatus 1, various operation elements 110 are provided.

For example, as the operation elements 110, operation elements in various forms such as keys, a dial, and press/rotation-combined operation elements are arranged and realize various operation functions. With the operation elements 110, the user is allowed to perform, for example, a menu operation, a reproduction operation, a mode selection operation, a focus operation, a zoom operation, an operation to select a parameter such as a shutter speed and an F-number, or the like. The detailed description of each of the operation elements 110 will be omitted. However, in the present embodiment, a shutter button 1105 and an assignable button 110C among the operation elements 110 are particularly shown.

The shutter button 1105 is used for performing a shutter operation (release operation) or an AF operation based on a half press.

The assignable button 110C is an operation element also called a custom button and is a button to which the user is allowed to assign any operation function. In the present embodiment, it is assumed that the function of operating the recording, reproduction, or the like of a sound memo is assigned to the assignable button 110C. That is, the user is allowed to perform the recording, reproduction, or the like of a sound memo by operating the assignable button 110C under a specific situation. For example, by pressing the assignable button 110C for a long time under a specific situation, the user is allowed to record a sound memo during the pressing. The recording of a sound memo is stopped when the user cancels the long-press of the assignable button 110C. Further, a recorded sound memo is reproduced when the user presses the assignable button 110C for a short time.

The shutter button 1105 is arranged on an upper surface on the right side of the body housing 100 and capable of being pressed and operated by the forefinger of a right hand in a state in which the user holds a holding part 103 with his/her right hand.

Further, the assignable button 110C is arranged at an upper part on the back side of the body housing 100 as shown in, for example, FIG. 3 and capable of being pressed and operated by the thumb of the right hand of the user.

Note that a dedicated operation button for performing a function related to a sound memo may be provided instead of the assignable button 110C.

Further, in a case where a display unit such as the display panel 101 has a touch panel function, the display panel 101 may serve as one of the operation elements 110.

On both lateral sides of the viewfinder 102, microphone holes 104 are formed. A microphone hole 104 on the left side as seen from the photographer is a microphone hole 104L, and a microphone hole 104 on the right side as seen from the photographer is a microphone hole 104R. With the formation of the microphone hole 104L and the microphone hole 104R, the imaging apparatus 1 is capable of acquiring an environment sound or a sound produced by the photographer as a stereo sound. In each of the microphone holes 104, a microphone not shown is disposed.

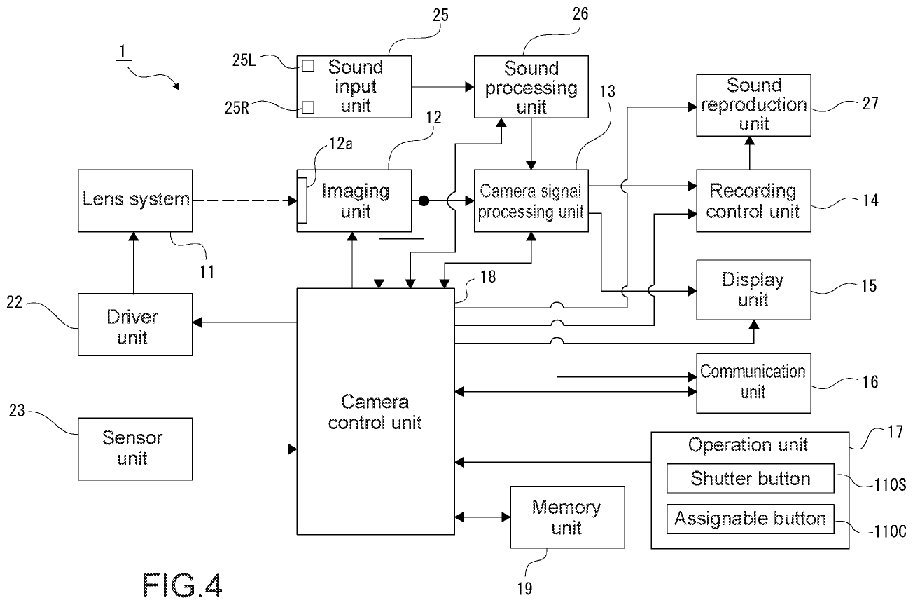

FIG. 4 shows the internal configuration of the imaging apparatus 1 including the lens barrel 2. The imaging apparatus 1 has, for example, a lens system 11, an imaging unit 12, a camera signal processing unit 13, a recording control unit 14, a display unit 15, a communication unit 16, an operation unit 17, a camera control unit 18, a memory unit 19, a driver unit 22, a sensor unit 23, a sound input unit 25, and a sound processing unit 26.

The lens system 11 includes a lens such as a zoom lens and a focus lens, an aperture mechanism, or the like. By the lens system 11, light (incident light) from an object is introduced and condensed into the imaging unit 12.

The imaging unit 12 is configured to have, for example, an image sensor 12a (imaging element) such as a complementary metal-oxide semiconductor (CMOS) type and a charge-coupled device (CCD) type.

The imaging unit 12 applies, for example, correlated double sampling (CDS) processing, automatic gain control (AGC) processing, or the like to an electric signal obtained by photoelectrically converting light received by the image sensor 12a, and further applies analog/digital (A/D) conversion processing to the signal. Then, the imaging unit 12 outputs an imaging signal to the subsequent camera signal processing unit 13 or the camera control unit 18 as digital data.

The camera signal processing unit 13 is constituted as an image processing processor by, for example, a digital signal processor (DSP) or the like. The camera signal processing unit 13 applies various signal processing to a digital signal (captured image signal) from the imaging unit 12. The camera signal processing unit 13 performs, for example, pre-processing, synchronization processing, YC generation processing, resolution conversion processing, file formation processing, or the like as a camera process.

In the pre-processing, the camera signal processing unit 13 performs clamp processing to clamp the black level of R, G, and B at a prescribed level, correction processing between the color channels of R, G, and B, or the like on a captured image signal from the imaging unit 12. In the synchronization processing, the camera signal processing unit 13 applies color separation processing to cause image data on each pixel to have all color components of R, G, and B. For example, with an imaging element using the color filter of a Bayer array, the camera signal processing unit 13 applies demosaic processing as color separation processing.

In the YC generation processing, the camera signal processing unit 13 generates (separates) a brightness (Y) signal and a color (C) signal from the image data of R, G, and B.

In the resolution conversion processing, the camera signal processing unit 13 applies resolution conversion processing to image data to which various signal processing has been applied.

In the file formation processing, the camera signal processing unit 13 performs, for example, compressing coding for recording or communication, formatting, generation or addition of metadata, or the like on, for example, image data to which the above-mentioned various processing has been applied to generate a file for recording or communication.

The camera signal processing unit 13 generates an image file PF in a format such as a joint photographic experts group (JPEG), a tagged image file format (TIFF), and a graphics interchange format (GIF) as, for example, a still image file. Further, it is also assumed that the camera signal processing unit 13 generates an image file PF in an MP4 format or the like used for recording a moving image and a sound based on MPGE-4.

Note that the camera signal processing unit 13 is also assumed to generate an image file PF as RAW image data.

The camera signal processing unit 13 generates metadata as data containing information regarding processing parameters inside the camera signal processing unit 13, various control parameters acquired from the camera control unit 18, information showing the operation state of the lens system 11 or the imaging unit 12, mode setting information, and imaging environment information (such as the date and time and a place).

The recording control unit 14 performs recording and reproduction on, for example, a recording medium constituted by a non-volatile memory. The recording control unit 14 performs processing to record an image file of moving-image data, still-image data, or the like, a thumbnail image, or the like on, for example, a recording medium.

The actual form of the recording control unit 14 is assumed in various ways. For example, the recording control unit 14 may be constituted as a flash memory and its writing/reading circuit included in the imaging apparatus 1. Further, the recording control unit 14 may be a recording medium detachable from the imaging apparatus 1, for example, a form of a card recording reproduction unit that accesses a memory card (such as a portable flash memory) to perform recording and reproduction. Further, the recording control unit 14 may be realized as a hard disk drive (HDD) or the like that is a form included in the imaging apparatus 1.

The display unit 15 is a display unit that performs various displays for the photographer and is, for example, the display panel 101 or the viewfinder 102 constituted by a display device such as a LCD panel and an EL display arranged in the housing of the imaging apparatus 1.

The display unit 15 causes various information to be displayed on a display screen on the basis of an instruction from the camera control unit 18.

For example, the display unit 15 causes a reproduction image of image data read from a recording medium in the recording control unit 14 to be displayed.

Further, after receiving image data of a captured image of which the resolution has been converted to perform a display by the camera signal processing unit 13, the display unit 15 may perform a display on the basis of the image data of the captured image according to an instruction from the camera control unit 18. Thus, a so-called through-image (a monitoring image of an object) that is a captured image during the confirmation of a composition, the recording of a moving image, or the like is displayed.

Further, the display unit 15 causes various operation menus, icons, messages, or the like, that is, information representing a graphical user interface (GUI) to be displayed on the screen according to an instruction from the camera control unit 18.

The communication unit 16 performs data communication or network communication with external equipment in a wired or wireless fashion.

The communication unit 16 transmits and outputs captured image data (a still-image file or a moving-image file) to, for example, an external display apparatus, a recording apparatus, a reproduction apparatus, or the like.

Further, the communication unit 16 is capable of performing communication via various networks 6 such as the Internet, a home network, and a LAN as a network communication unit and transmitting and receiving various data to/from servers, terminals, or the like on the networks. In the present embodiment, for example, the communication unit 16 performs communication processing to upload captured image data (such as the above-mentioned image files) to the FTP server 4.

Further, in the present embodiment, the communication unit 16 performs communication with an information processing apparatus to transfer an image file PF or a sound file AF.

An input device operated by the user to perform various operation inputs is collectively shown as the operation unit 17. Specifically, the operation unit 17 shows various operation elements (such as keys, a dial, a touch panel, and a touch pad) provided in the housing of the imaging apparatus 1.

The operation unit 17 detects an operation by the user and transmits a signal corresponding to the input operation to the camera control unit 18.

As the operation unit 17, the shutter button 1105 or the assignable button 110C described above is provided.

The camera control unit 18 is constituted by a microcomputer (processor) including a central processing unit (CPU).

The memory unit 19 stores information or the like used by the camera control unit 18 to perform processing. In the figure, a read-only memory (ROM), a random access memory (RAM), a flash memory, or the like is collectively shown as the memory unit 19.

The memory unit 19 may be a memory area included in a microcomputer chip serving as the camera control unit 18, or may be constituted by a separate memory chip.

The camera control unit 18 performs a program stored in the ROM, the flash memory, or the like of the memory unit 19 to control the entire imaging apparatus 1.

The camera control unit 18 controls the operations of necessary respective units with respect to, for example, the control of a shutter speed of the imaging unit 12, instructions to perform various signal processing in the camera signal processing unit 13, an imaging operation or a recording operation according to the operation of the user, the operation of reproducing a recorded image file, the operation of the lens system 11 such as zooming, focusing, and aperture adjustment in the lens barrel, the operation of a user interface, processing of the sound processing unit 26, or the like.

The RAM in the memory unit 19 is used for temporarily storing data, a program, or the like as a working area used when the CPU of the camera control unit 18 processes various data.

The ROM or the flash memory (non-volatile memory) in the memory unit 19 is used for storing an application program for various operations, firmware, various setting information, or the like, besides an operating system (OS) used by the CPU to control respective units and a content file such as an image file.

The various setting information includes the above-mentioned FTP setting information, exposure setting serving as setting information regarding an imaging operation, shutter speed setting, mode setting, white balance setting serving as setting information regarding image processing, color setting, setting on image effect, setting regarding processing of the sound processing unit (for example, setting of sound volume, sound quality, and other parameters regarding the processing), custom key setting or display setting serving as setting information regarding operability, or the like.

In the driver unit 22, a motor driver for a zoom-lens driving motor, a motor driver for a focus-lens driving motor, a motor driver for an aperture-mechanism motor, or the like is, for example, provided.

These motor drivers apply a driving current to a corresponding driver according to an instruction from the camera control unit 18 to perform the movement of a focus lens or a zoom lens, the opening/closing of an aperture blade of an aperture mechanism, or the like.

Various sensors installed in the imaging apparatus 1 are collectively shown as the sensor unit 23. An inertial measurement unit (IMU) is, for example, installed as the sensor unit 23. The sensor unit 23 is capable of detecting an angular speed with, for example, the angular speed (gyro) sensor of the three axes of a pitch, a yaw, and a roll and detecting acceleration with an acceleration sensor.

Further, a position information sensor, an illumination sensor, or the like is, for example, installed as the sensor unit 23.

The sound input unit 25 has, for example, a microphone, a microphone amplifier, or the like and outputs a sound signal in which a surrounding sound is collected. In the present embodiment, the microphone 25L corresponding to the microphone hole 104L and the microphone 25R corresponding to the microphone hole 104R are provided as microphones.

The sound processing unit 26 performs processing to convert a sound signal obtained by the sound input unit 25 into a digital sound signal, AGC processing, sound quality processing, noise reduction processing, or the like. Sound data that has been subjected to these processing is output to the camera signal processing unit 13 or the camera control unit 18.

For example, sound data is processed as sound data accompanying a moving image by the camera control unit 18 when the moving image is captured.

Further, sound data serving as a sound memo input by the photographer during reproduction, imaging, or the like is converted into a sound file AF by the camera signal processing unit 13 or the camera control unit 18.

A sound file AF may be recorded on a recording medium to be associated with an image file PF by the recording control unit 14, or may be transmitted and output from the communication unit 16 together with an image file PF.

The sound reproduction unit 27 includes a sound signal processing circuit, a power amplifier, a speaker, or the like and performs the reproduction of a sound file AF that has been recorded on a recording medium by the recording control unit 14. When a sound file AF is, for example, reproduced, the sound data of the sound file AF is read by the recording control unit 14 on the basis of the control of the camera control unit 18 and transferred to the sound reproduction unit 27. The sound reproduction unit 27 performs necessary signal processing on the sound data or converts the sound data into an analog signal and outputs a sound from the speaker via the power amplifier. Thus, the user is allowed to hear a sound recorded as a sound memo.

Note that when a moving image is reproduced, a sound accompanying the moving image is reproduced by the sound reproduction unit 27.

### 3. Sound Memo Related to Sequentially Shot Images

A UI screen in the display panel 101 of the imaging apparatus 1 will be described. In particular, a display example related to a continuously-shot image and a sound memo will be mainly described. Note that each screen in the following description is an example of a screen displayed on the display panel 101 of the display unit 15 when the camera control unit 18 of the imaging apparatus 1 performs UI control.

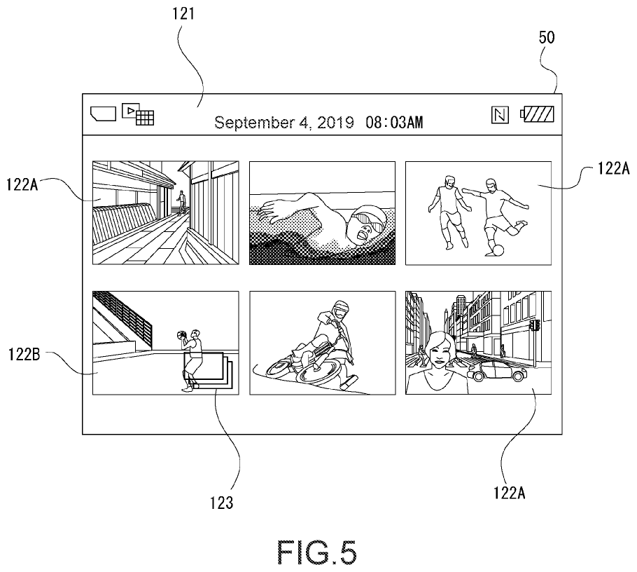

FIG. 5 shows an image list screen 50 through which the user is allowed to visually recognize images (still images or moving images) captured by the imaging apparatus 1 in list form. The image list screen 50 is, for example, a screen displayed on the display panel 101 in a reproduction mode.

In the image list screen 50, a status bar 121 in which an indicator showing time information or a battery charged state or the like is displayed and thumbnail images 122 corresponding to a plurality of captured images are displayed.

As the thumbnail images 122, any of thumbnail images 122A each showing one image captured in a single-shooting mode and thumbnail images 122B each showing an image group in which a plurality of images captured in a continuous-shooting mode is put together are displayed.

In the thumbnail images 122B each showing an image group, one of a plurality of images contained in the image groups is selected as a representative image. A captured image used for the thumbnail images 122B may be selected by the user or may be automatically selected. For example, the image captured at first among a plurality of images captured in the continuous-shooting mode is automatically selected as a representative image and used for the thumbnail images 122B.

In the thumbnail images 122B each showing an image group, an image group icon 123 showing an image group is displayed so as to overlap.

A plurality of images captured in the continuous-shooting mode may be automatically put together and generated as an image group, or a plurality of images selected by the user may be generated as an image group.

When any of the thumbnail images 122 is selected and operated in the image list screen 50, the display of the display panel 101 is switched to a next screen.

For example, when a thumbnail image 122A showing an image captured in the single-shooting mode is selected, the display is switched to a screen in which the selected image is largely displayed.

Further, when a thumbnail image 122B showing an image group is selected, the display is switched to a screen in which the selected image group is displayed (see FIG. 6).

A screen shown in FIG. 6 is a screen that is dedicated to an image group in which a plurality of images is displayed without being developed, and that is called an image-group pre-development display screen 51.

In the image-group pre-development display screen 51, a representative image 124 and a frame image 125 showing a state in which a plurality of images is contained in an image group are displayed.

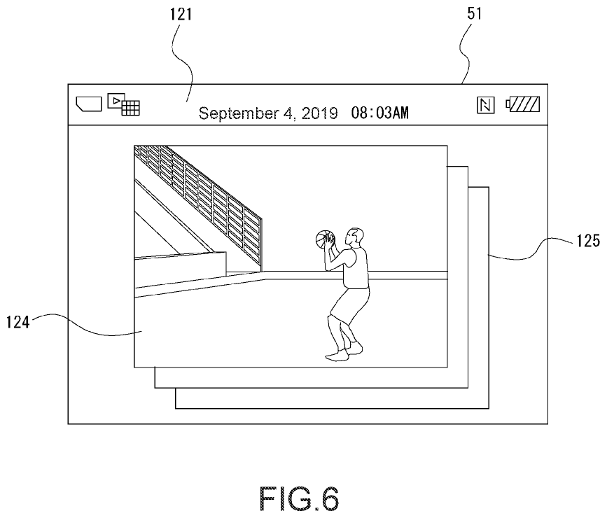

When the representative image 124 or the like in the image-group pre-development display screen 51 is operated, an image-group post-development display screen shown in FIG. 7 is displayed on the display panel 101.

In the image-group post-development display screen 52, one of the plurality of images belonging to the image group is selected and displayed. In FIG. 7, the image captured at first among a series of image groups captured in the continuous-shooting mode is displayed as a display image 126.

Further, in the image-group post-development display screen 52, a count display 127 showing the total number of the images belonging to the image group and the order of the displayed image is displayed. The count display 127 in FIG. 7 shows a state in which the first image in the image group including 14 images has been displayed.

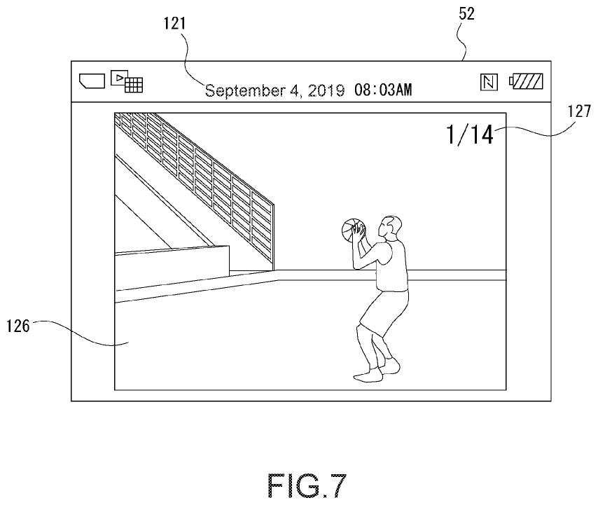

In the image-group post-development display screen 52, it is possible to perform an image feeding operation through a swipe operation or a button operation. The image feeding operation is an operation to change the display image 126 to another image. FIG. 8 shows the image-group post-development display screen 52 displayed after the image feeding operation has been performed a plurality of times.

FIG. 8 shows a state in which the fifth image among the 14 images belonging to the image group has been displayed.

When the assignable button 110C is pressed for a long time from the state shown in FIG. 8, the recording of a sound memo is started. The recording of the sound memo is completed in a case where the long-pressed state of the assignable button 110C is cancelled or in a case where the recording time of the sound memo reaches a prescribed time.

Further, the sound memo is stored to be associated with the display image 126 displayed on the display panel 101 when the assignable button 110C is pressed for a long time. In this example, the assignable button 110C is pressed for a long time from the state shown in FIG. 8. Therefore, the sound memo is associated with the fifth image of the image group.

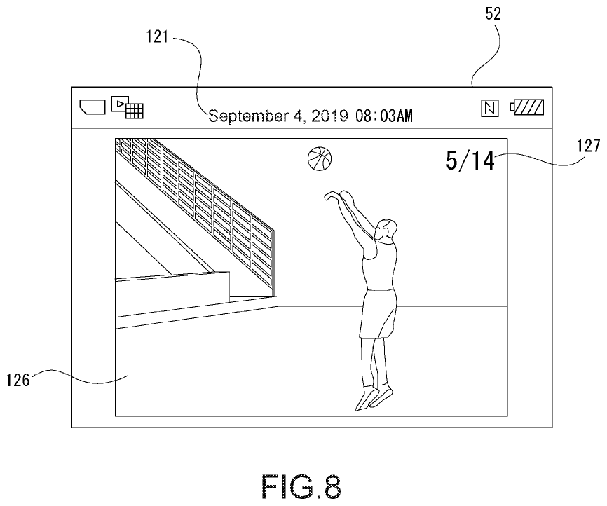

During the recording of the sound memo, a sound memo recording screen 53 shown in FIG. 9 is displayed on the display panel 101.

In the sound memo recording screen 53, a recording icon 128 showing a state in which the sound memo is being recorded, a recording level gauge 129 showing the respective input levels of the microphone 25L and the microphone 25R, and a recording time bar 130 showing a recording time and a remaining recording time are displayed.

In an example shown in FIG. 9, a maximum recording time is set at 60 seconds, and the sound memo has been recorded for 35 seconds.

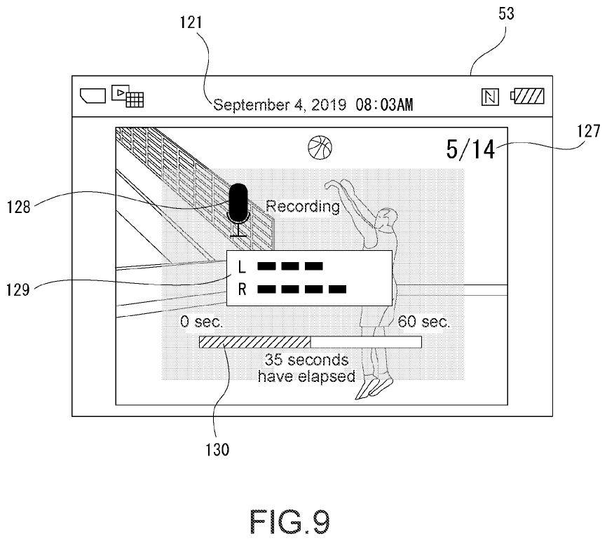

After the recording of the sound memo for 60 seconds is completed or after the long-pressed state of the assignable button 110C is cancelled before the elapse of the maximum recording time, the image-group post-development display image 52 shown in FIG. 10 is displayed on the display panel 101. FIG. 10 shows a state in which the fifth image among the 14 images belonging to the image group is displayed like FIG. 8. Further, a sound memo icon 131 showing a state in which the image is associated with the sound memo is displayed so as to overlap the image.

When an operation to cancel the developed display of the image group such as the press of a return button is performed from the state shown in FIG. 10, the image-group pre-development display screen 51 shown in FIG. 6 is displayed on the display panel 101. The image group shown in FIG. 6 is put in a state in which the sound memo corresponding to the fifth image has been recorded. However, since the representative image 124 displayed on the display panel 101 is the first image belonging to the image group and no sound memo exists in the first image, the sound memo icon 131 is not displayed.

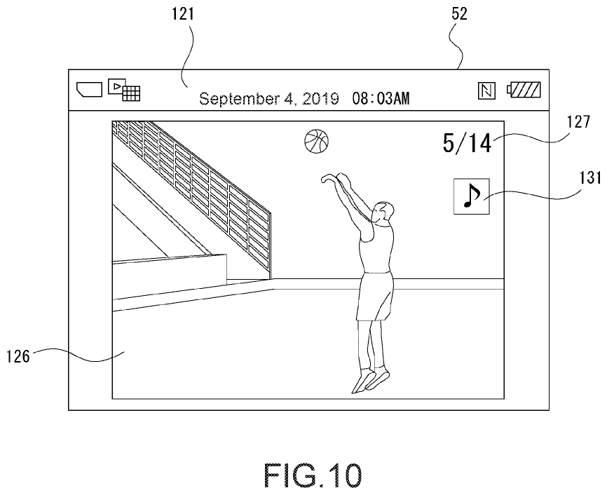

Note that in a case where a sound memo has been recorded for the representative image 124, the sound memo icon 131 is displayed in the image-group pre-development display screen 51 as shown in FIG. 11.

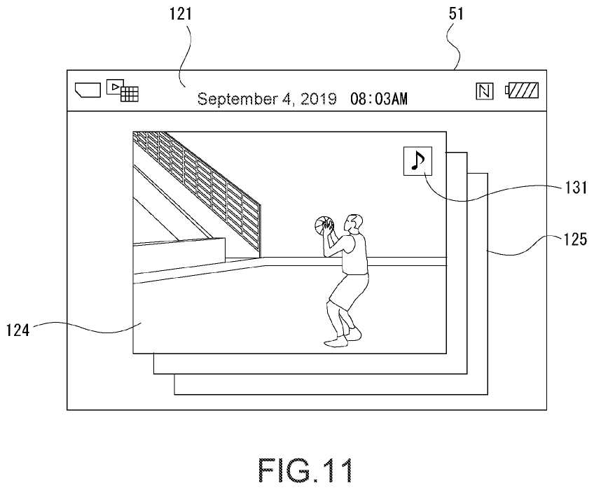

Modified examples of the image-group pre-development display image 51 displayed when the developed display is cancelled after the fifth image is associated with the sound memo will be described with reference to FIGS. 11 and 12.

In the above description, the sound memo icon 131 is displayed in the image-group pre-development display screen 51 as shown in FIG. 11 in a case where the sound memo corresponding to the representative image 124 has been recorded. In a modified example, no sound memo exists in the first image selected as the representative image 124, but at least one image (for example, the fifth image) among the images belonging to the image group is associated with a sound memo. Therefore, in order to show a state in which the image belonging to the image group contains the sound memo, the sound memo icon 131 may be displayed as shown in FIG. 11.

Thus, the user is allowed to recognize the presence or absence of an image in which a corresponding sound memo exists through the sound memo icon 131 without performing the developed display of the image group.

Further, in a modified example shown in FIG. 12, one of images (for example, the fifth image) in which a corresponding sound memo exists among the images belonging to the image group is newly selected as the representative image 124.

That is, the user is allowed to recognize, only by visually recognizing the image-group pre-development display screen 51 shown in FIG. 12, a state in which a corresponding sound memo exists in any of the images of the image group and at least one of the images in which the sound memo exists is an image selected as the representative image 124.

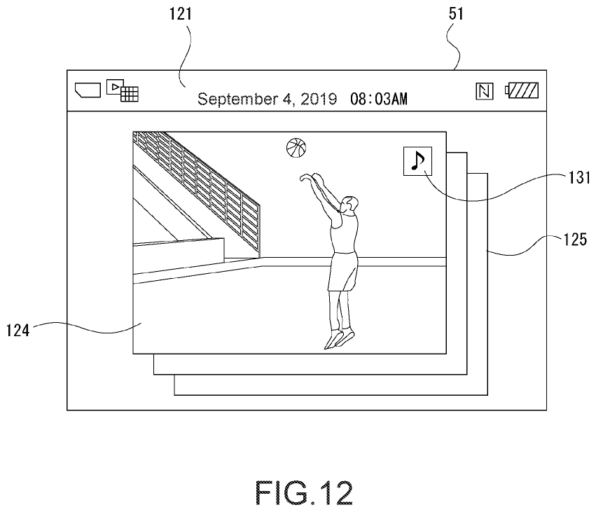

Meanwhile, in a case where an operation to reproduce a sound memo such as the short-press of the assignable button 110C is performed in, for example, the image-group post-development display screen 52 shown in FIG. 10, that is, in the image-group post-development display screen 52 in which the image where the sound memo exists is displayed as the display image 126, a sound memo reproduction screen shown in FIG. 13 is displayed on the display panel 101.

In the sound memo reproduction screen 54, the sound memo icon 131, a reproduction icon 132 showing a state in which the sound memo is being reproduced, and a reproduction time bar 133 showing the recording time of the sound memo and an elapsed reproduction time are displayed on the image associated with the sound memo that is a reproduced target.

The reproduction icon 132 is, for example, an icon image that is the same in shape and different in color from the recording icon 128 shown in FIG. 9.

In an example shown in FIG. 13, the recording time of the sound memo is 48 seconds, and the segment of the sound memo at 27 seconds since the start of the reproduction is being reproduced. Further, a reproduction level gauge 134 showing the reproduction levels of a left channel and a right channel is displayed in the sound memo reproduction screen 54.

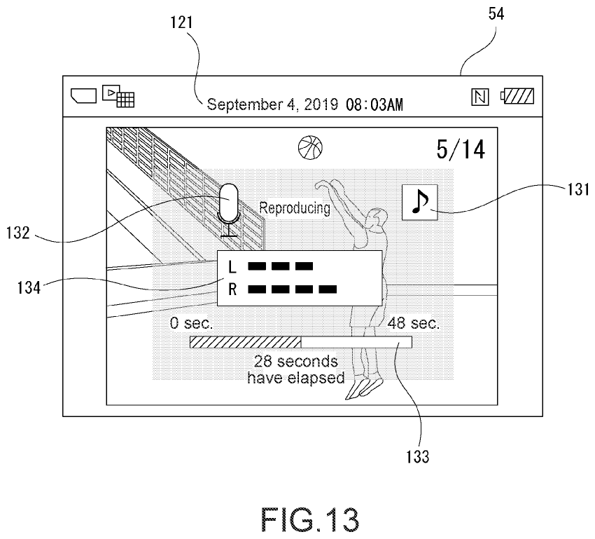

When an operation to perform the deletion or the like of the sound memo is performed in the image-group post-development display screen 52 shown in FIG. 10, that is, in the image-group post-development display screen 52 in which the image where the corresponding sound memo exists is displayed as the display image 126, a deletion target selection screen 55 shown in FIG. 14 is displayed on the display panel 101.

In the deletion target selection screen 55, three operable alternatives are presented to the user. Specifically, a first alternative 135 for deleting both an image file PF and a sound file AF serving as a sound memo, a second alternative 136 for deleting only the sound file AF serving as a sound memo while leaving the image file PF, and a third alternative 137 for cancelling the deletion operation are displayed.

The image file PF or the sound file AF deleted in a case where any of the first alternative 135 and the second alternative 136 is operated is a file related to the display image 126 displayed on the display panel 101 during the deletion operation.

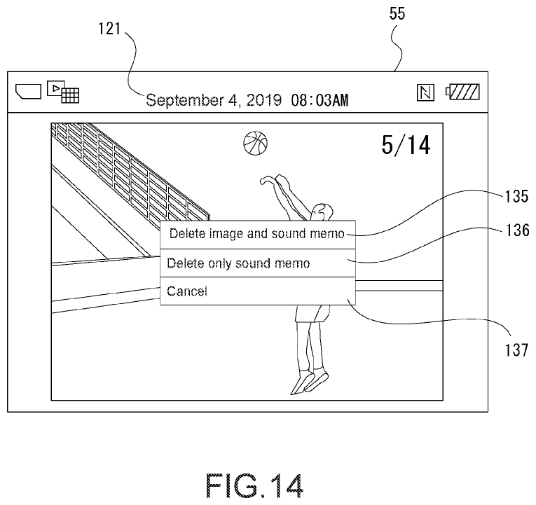

In a case where any of the first alternative 135 and the second alternative 136 is operated, a deletion-in-process screen 56 shown in FIG. 15 is displayed on the display panel 101.

In the deletion-in-process screen 56, a message 138 showing a state in which the deletion of the file is in process, a deletion bar 139 showing the progress of deletion processing, and a cancel button 140 for cancelling the deletion processing are displayed.

When the user operates the cancel button 140 in a state in which the deletion-in-process screen 56 has been displayed, the deletion of the file that is a deleted target is cancelled.

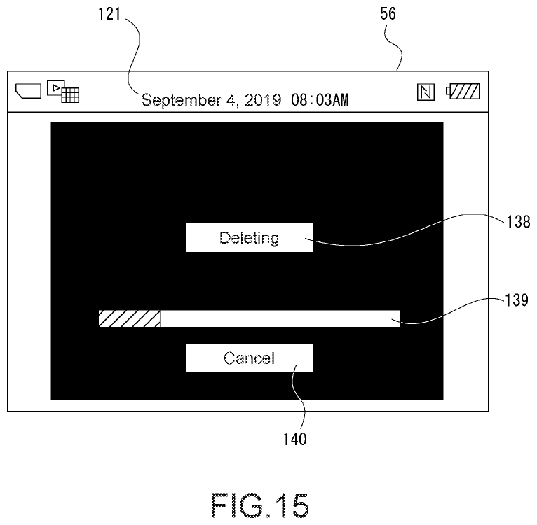

When a file deletion time elapses without the operation of the cancel button 140, a deletion completion screen 57 shown in FIG. 16 is displayed on the display panel 101.

In the deletion completion screen 57, a message 141 showing a state in which the deletion has been completed and a confirmation button 142 operated to confirm the completion of the deletion are displayed.

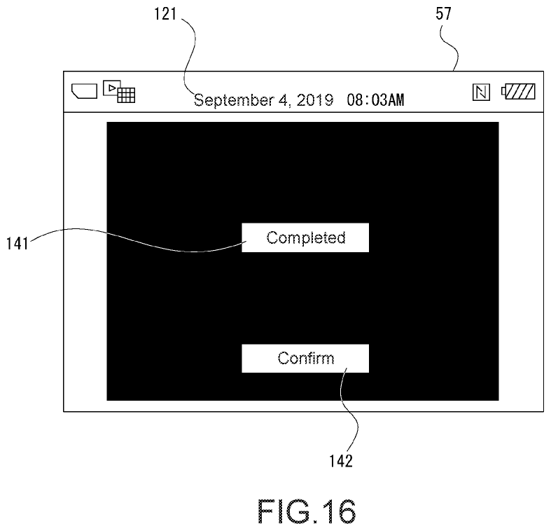

When an operation to perform the deletion or the like is performed in the image-group pre-development display screen 51 shown in FIG. 6, a deletion selection screen 58 shown in FIG. 17 is displayed on the display panel 101.

In the deletion selection screen 58, an all-deletion alternative 143 for deleting all the images belonging to the image group in a lump and a cancel alternative 144 for cancelling the deletion operation are displayed.

Note that when the all-deletion alternative 143 is operated in a case where a sound file AF serving as a sound memo associated with any of the images belonging to the image group exists, not only an image file PF but also the associated sound file AF is assumed to be deleted. Note that an alternative for deleting only a sound file AF serving as a sound memo associated with any of the images belonging to the image group may be provided.

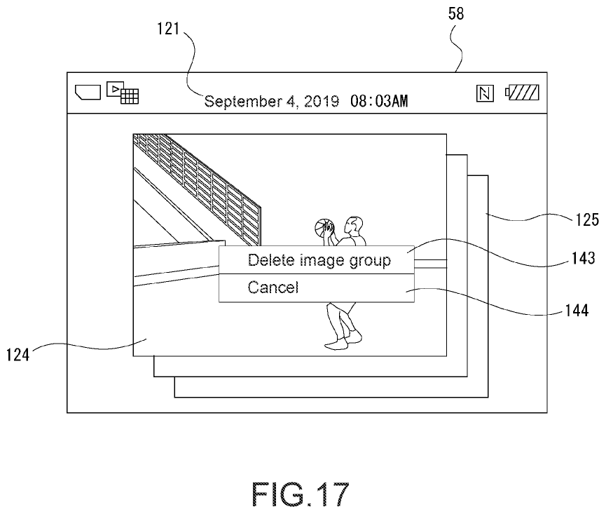

When the deletion operation is performed in a state in which an image not associated with a sound memo is displayed as the display image 126 (for example, the state shown in FIG. 7), a deletion selection screen 59 shown in FIG. 18 is displayed on the display panel 101.

In the deletion selection screen 59, a deletion alternative 145 for deleting an image file PF and a cancel alternative 146 for cancelling the deletion operation are displayed.

When the deletion alternative 145 is operated, the deletion of the image is started. As a result, the deletion-in-process screen 56 shown in FIG. 15 is, for example, displayed.

Further, when the cancel alternative 146 is operated, the deletion operation is cancelled. As a result, the display returns to a screen (for example, the screen shown in FIG. 7) before the cancel operation.

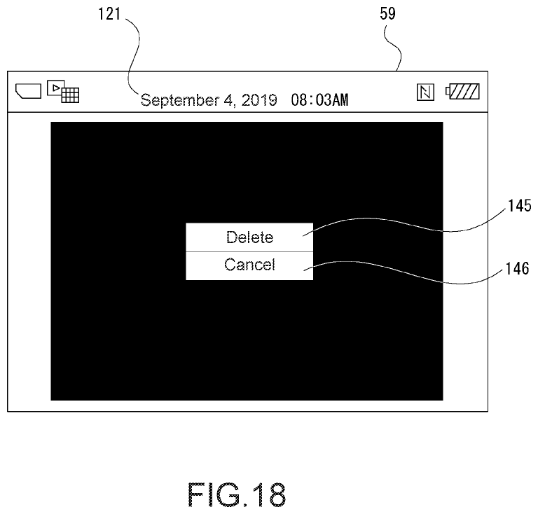

Subsequently, a processing example of the camera control unit 18 with respect to an assignable button operation will be described with reference to FIG. 19. As described above, it is assumed that the assignable button 110C is assigned to the operation of the sound memo.

The camera control unit 18 determines in Step S201 whether or not a prescribed time has elapsed since the press of the assignable button 110C. In a case where the prescribed time has not elapsed, the camera control unit 18 determines in Step S202 whether or not the assignable button 110C is being pressed.

In a case where the assignable button 110C is being pressed, the camera control unit 18 returns to Step S201 and determines whether or not the prescribed time has elapsed.

That is, in a case where the assignable button 110C is pressed for a long time, the camera control unit 18 repeatedly performs the processing of Step S201 and the processing of Step S202 until the elapse of the prescribed time and proceeds from Step S201 to Step S203 at a point at which the prescribed time has elapsed.

On the other hand, in a case where the pressed state of the assignable button 110C is cancelled before the elapse of the prescribed time, for example, in a case where the assignable button 110C is pressed for a short time, the camera control unit 18 proceeds from the processing of Step S202 to the processing of Step S208.

That is, processing performed in a case where the assignable button 110C is pressed for a long time is the processing of Step S203 and the processing of the subsequent steps, while processing performed in a case where the assignable button 110C is pressed for a short time is the processing of Step S208 and the processing of the subsequent steps.

In a case where the assignable button 110C is pressed for a long time, the camera control unit 18 performs control to start recording a sound memo in Step S203. For example, the camera control unit 18 starts a series of operations to record a sound signal input from the sound input unit 25 on a recording medium as a sound file AF through the processing of the sound processing unit 26, the camera signal processing unit 13, and the recording control unit 14. For example, at this point, the camera control unit 18 starts processing to buffer sound data based on a sound input through the microphones 25L and 25R in the camera signal processing unit 13 for 60 seconds at a maximum.

The camera control unit 18 determines in Step S204 whether or not the assignable button 110C is being pressed. In a case where the assignable button 110C is being pressed, the camera control unit 18 determines in Step S205 whether or not a maximum recording time (for example, 60 seconds) has elapsed.

In a case where it is determined that the maximum recording time has not elapsed, that is, in a case where the assignable button 110C is being pressed but the maximum recording time has not elapsed, the camera control unit 18 returns to Step S204.

On the other hand, in a case where it is determined in Step S204 that the assignable button 110C is not being pressed or in a case where it is determined in Step S205 that the maximum recording time has elapsed, the camera control unit 18 performs recording stop control in Step S206. For example, the camera control unit 18 causes processing to buffer the sound signal input from the sound input unit 25 inside the camera signal processing unit 13 to be stopped through the processing of the sound processing unit 26.

Then, the camera control unit 18 causes processing to generate a sound file AF serving as a sound memo and store the same in a storage medium to be performed in Step S207. That is, the camera control unit 18 causes the camera signal processing unit 13 to perform compression processing, file format generation processing, or the like on buffered sound data and causes the recording control unit 14 to record data in a prescribed file data format (for example, a WAV file) on a recording medium.

In the manner described, the camera control unit 18 completes a series of the processing to record a sound memo shown in FIG. 19.

Thus, when the user continues to press the assignable button 110C, it is determined that the long-press of the assignable button 110C has occurred. As a result, sound memo recording processing is started. The sound memo recording processing is performed until the pressed state of the assignable button 110C is cancelled or until a recording time reaches the maximum recording time.

When the recording time reaches the maximum recording time or when the long-pressed state of the assignable button 110C is cancelled before the recording time reaches the maximum recording time, the recording of a sound memo is stopped.

In a case where it is determined in Step S202 that an operation to press the assignable button 110C for a short time has been performed, the camera control unit 18 determines in Step S208 whether or not a sound memo associated with an image displayed on the display panel 101 exists.

In a case where the associated sound memo does not exist, the camera control unit 18 completes the series of the processing shown in FIG. 19.

In a case where it is determined in Step S208 of FIG. 19 that the sound memo associated with the image exists, the camera control unit 18 performs control to start reproducing the sound memo in Step S209. For example, the camera control unit 18 instructs the recording control unit 14 to start reproducing a specific sound file AF and instructs the sound reproduction unit 27 to perform a reproduction operation.

During the reproduction of the sound memo, the camera control unit 18 determines in Step S210 whether or not the reproduction has been completed, determines in Step S211 whether or not an operation to complete the reproduction has been detected, and determines in Step S212 whether or not an operation to change a volume has been detected.

In a case where it is determined in Step S210 that the reproduction has been completed, that is, in a case where a reproduction output has reached the last of the sound data, the camera control unit 18 performs control to stop the reproduction with respect to the reproduction operations of the recording control unit 14 and the sound reproduction unit 27 to complete the series of the processing shown in FIG. 19 in Step S214.

Further, in a case where it is determined in Step S210 that the reproduction has not been completed, the camera control unit 18 determines in Step S211 whether or not the operation to complete the reproduction has been detected. In a case where the operation to complete the reproduction has been detected, the camera control unit 18 performs the control to stop the reproduction with respect to the reproduction operations of the recording control unit 14 and the sound reproduction unit 27 to complete the series of the processing shown in FIG. 19 in Step S214.

In addition, in a case where the operation to complete the reproduction has not been detected, the camera control unit 18 determines in Step S212 whether or not the operation to change a volume has been detected. In a case where the operation to change the volume has been detected, the camera control unit 18 performs control to change a reproduced volume with respect to the sound reproduction unit 27 in Step S213 and returns to Step S210. In a case where the operation to change a volume has not been detected, the camera control unit 18 returns to Step S210 from Step S212.

Note that although omitted in each of the figures, processing to stop the display of the display panel 101 is appropriately performed when an operation to turn off a power supply has been detected.

Although only the assignable button 110C is provided with the function related to the sound memo has been described in the above example, the function related to the sound memo may be executed by operating another operation element 110 other than the assignable button 110C. In that case, similar action and effect can be obtained by replacing processing to detect an operation of the assignable button 110C by processing to detect an operation of that operation element 110. Alternatively, the function related to the sound memo may be executed by operating a plurality of buttons in a predetermined procedure rather than providing only one operation element 110 with the function related to the sound memo. For example, various functions may be executed by performing an operation to display a menu screen in a state in which one image is displayed on the panel 101, performing an operation to select an item related to the sound memo from the displayed menu, and selecting a record function or reproduction function of the sound memo as a function to be executed from among them.

In that case, it is only necessary to execute processing to detect that that menu item has been selected instead of detecting an operation of the assignable button 110C.

Some processing examples are assumed in a case where the record operation of the sound memo (a detected operation in Step S201 of FIG. 19) has been detected in a state in which the sound memo has been associated with the image.

For example, a new sound memo may be prevented from being associated with that image unless the sound memo is deleted. In that case, after the processing of Step S201, the processing to determine whether or not the sound memo associated with the target image is performed. In a case where the sound memo has not been associated with the target image, the processing of Step S203 and the processing of the subsequent steps are performed.

Further, in a case where the sound memo associated with the target image has not reached the maximum record time, additional record of the sound memo may be permitted. In a case where the sound memo has reached the maximum record time, the record operation of the sound memo may be made invalid. In that case, whether or not the sound memo associated with the target image exists is determined after detecting the record operation in Step S201. In a case where the sound memo associated with the target image exists, whether or not the record time remains is determined. In a case where the record time remains, processing to perform additional record is performed.

In addition, in a case where the record operation of the sound memo has been performed even if the sound memo associated with the target image exists, the sound memo associated with the target image may be discarded and a new sound memo may be recorded.

Furthermore, a plurality of sound memos may be associated with one image. In that case, the sound file AF for the sound memo is given a file name such that the image file PF associated with the sound file AF can be identified and a plurality of sound memos has different file names.

In each of the above-mentioned examples, the sound file AF for the sound memo is associated with the single image file PF. Alternatively, record of the sound file AF associated with the entire image group may be permitted. In that case, it can be realized by recording information for identifying the sound file AF associated with the entire image group in a management file for containing a plurality of images as one image group, for example.

### 4. Processing Related to Microphone Sound

In this embodiment, the microphones 25L and 25R are used for collecting sound for the sound memo.

The microphones 25L and 25R are installed for the use for collecting a surrounding sound when capturing a moving image. That is, the microphones 25L and 25R are commonly used for collecting the moving image sound and the sound memo.

It should be noted that in the present disclosure, a sound synchronized with the moving image recorded together with the moving image will be referred to as a “moving image sound” for distinguishing it from the sound memo for the sake of explanation.

As described above, sound signals collected by the microphones 25L and 25R are converted into digital sound signals (sound data) by the sound processing unit 26 and the AGC processing, the sound quality processing, the noise reduction processing, and the like are performed. In this embodiment, control is performed such that the parameters regarding such sound signal processing are different at the time of recording the moving image (that is, at the time of recording the moving image sound) and the time of recording the sound memo.

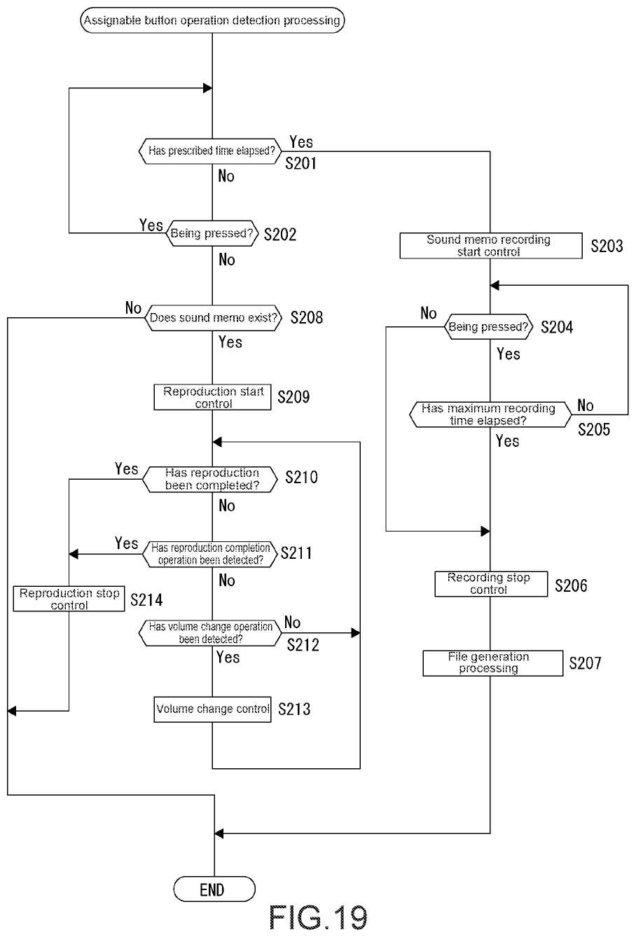

FIG. 20 shows an example of control processing of the camera control unit 18 regarding the parameter of the sound processing unit 26.

The processing of FIG. 20 is microphone preparation processing to be called for when record of the sound data is started. The camera control unit 18 performs this microphone preparation processing when the user performs the record operation of the moving image and the moving image record is started, when a record stand-by operation is performed and the moving image record can be started in accordance with the subsequent operation, or when the record operation of the sound memo is performed, for example.

In Step S301, the camera control unit 18 determines whether the current microphone preparation processing is processing in a situation where the moving image sound is recorded or processing in a situation where the sound memo is recorded.

Then, in the situation where the sound memo is recorded, the camera control unit 18 proceeds to Step S302 and performs parameter setting for the sound memo with respect to the sound processing unit 26.

Further, in the situation where the moving image sound is recorded, the camera control unit 18 proceeds to Step S303 and performs parameter setting for the moving image sound with respect to the sound processing unit 26.

Then, in either case, the camera control unit 18 performs ON control on the microphones 25L and 25R (powering the microphone amplifier or the like) in Step S304 and causes the microphones 25L and 25R to start supply of the collected sound signal into the sound processing unit 26.

With such processing, control is performed such that processing properties or the like at the sound processing unit 26 are different at the time of recording the sound memo and the time of recording the moving image sound. Specific examples of the change of the processing according to the parameter setting of Steps S302 and S303 will be shown hereinafter.

AGC Property

The sound processing unit performs the AGC processing on sound signals that are analog signals obtained by the microphones 25L and 25R or sound data that has been converted into digital data. The AGC property is changed by changing the parameters of this AGC processing.

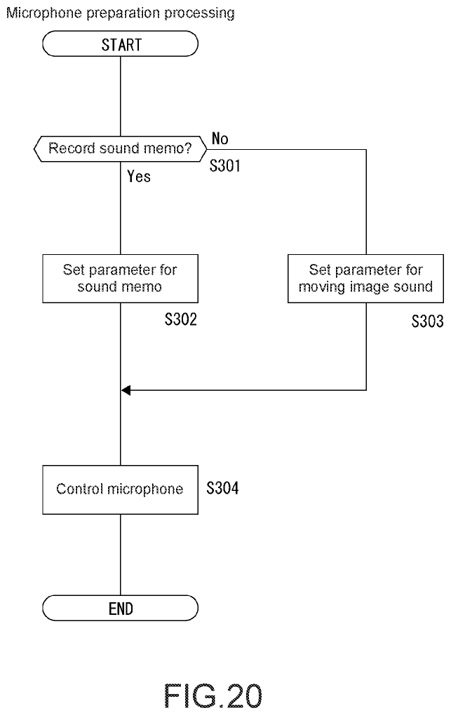

FIG. 21 shows an example of an AGC property Sm at the time of recording the moving image and an AGC property Sv at the time of recording the sound memo. The vertical axis indicates an output (dBFS) and the horizontal axis indicates an input sound pressure (dBSPL).

Regarding the moving image sound, setting is performed such that a high-quality sound can be obtained in accordance with a moving image by performing level control not to produce sound distortion while securing a dynamic range as wide as possible. Therefore, a property like the AGC property Sm, for example, is set.

Meanwhile, as the sound memo, it is important to be able to clearly hear the sound memo as a voice in the subsequent reproduction. Therefore, it is desirable to make it easy to hear even a small voice by increasing the sound pressure level and to make it easy to compress sound for avoiding a distortion due to a too high sound pressure as much as possible. Further, it is not important to secure a dynamic range. In view of this, a property like the AGC property Sv, for example, is set.

With such control, the moving image sound and the sound memo are recorded as sound data having suitable sound pressure levels meeting the respective purposes.

It should be noted that not in the AGC processing, or in a case where a fixed input gain is given for the sound signal (the sound data) at a pre-stage of the AGC processing or the like, the input gain may be set to be variable.

In that case, the input gain may be switched between the moving image sound and the sound memo through the parameter control. For example, the input gain may be low, corresponding to the sound memo input at a position extremely close to the imaging apparatus 1.

Further, the user may be able to variably set the input gain of the moving image sound. In view of this, the input gain may be a gain set by the user for the moving image sound and the input gain may be a fixedly set gain for the sound memo.

Frequency Property Adjustment of the frequency property, band restriction, or the like is performed by filtering processing or equalizing processing with respect to the sound data in the sound processing unit 26. In this case, processing suitable for each of the sound memo and the moving image sound is set to be performed by switching the parameter to set a frequency property.

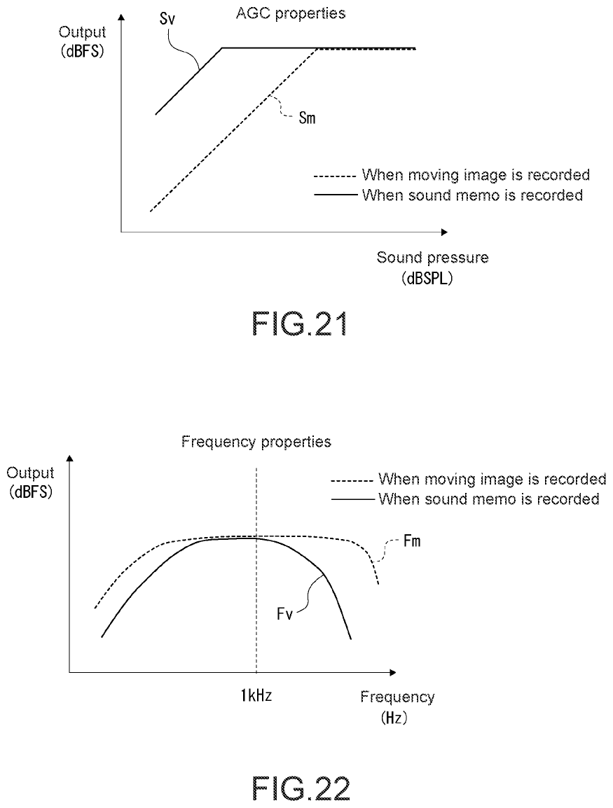

FIG. 22 shows an example of a frequency property Fm at the time of recording the moving image and a frequency property Fv at the time of recording the sound memo. The vertical axis indicates an output (dBFS) and the horizontal axis indicates a frequency (Hz).

Regarding the moving image sound, it is desirable to record various environment sounds in addition to human voices. Therefore, the frequency property which is flat in a relatively wide band like the frequency property Fm, for example, is suitable.

On the other hand, the sound memo has a purpose for recording human voices and other sounds are considered as noise. In view of this, for example, the frequency property Fv having a relatively narrow band as a target is set using a frequency of about 1 kHz as the center.

Accordingly, human voices are easily collected while other environment sounds such as a wind blowing sound are attenuated.

Sampling Frequency

The sound processing unit 26 converts the analog sound signals obtained by the microphones 25L and 25R into the digital data by the A/D conversion processing. However, regarding the moving image sound, the sound processing unit 26 converts the analog sound signals into sound data having a sampling frequency of 48 kHz and 16-bit quantization. Accordingly, sound data having relatively high sound quality can be obtained.

Meanwhile, high sound quality is unnecessary in the case of the sound memo. In view of this, the parameter to designate the sampling frequency of the A/D conversion processing may be switched for lowering the sampling frequency of the A/D conversion processing to 32 kHz, 16 kHz, or the like, for example, in the case of recording the sound memo, for example. The amount of data of the sound data that is the sound memo is also reduced by lowering the sampling frequency.

The sound memo is saved in a file separate from the image file PF. That file is the sound file AF. Further, each of the sound file AF and the image file PF is transmitted also when performing an upload to the FTP server 4. Taking the fact that the sound file AF is additional information with respect to the image file PF into consideration, the data size reduction leads to reduction of the burden of necessary record capacity and reduction of the amount of data transmitted/transmission time, which is desirable.

It should be noted that the number of quantization bits may be reduced in the case of the sound memo if it is possible in view of the configuration.

Number of Channels

In this embodiment, the microphones 25L and 25R are prepared and two-channel stereo sound data is generated. As the moving image sound, sound record with a sense of presence is realized because it is a stereo sound.

By the way, although the sound memo may be stereo sound data, the necessity is not high in comparison with the moving image sound. In view of this, the parameter to designate the number of channels may be switched.

That is, the camera control unit 18 instructs the sound processing unit 26 to perform the processing of the stereo sound data with a channel setting parameter in the case of the moving image sound and instructs the sound processing unit 26 to perform the monophonic sound data processing in the case of the sound memo.

The monophonic sound data processing mixes an L channel sound signal and an R channel sound signal from the microphones 25L and 25R to generate a monophonic sound signal, for example, and performs necessary signal processing on the generated monophonic sound signal. Alternatively, only a sound signal from the microphone 25L or 25R may be used.

By making it two-channel stereo in the case of the moving image sound and making it monophonic in the case of the sound memo, the amount of data of the sound memo (the sound file AF) can be reduced. Therefore, the burden of necessary record capacity can be reduced. Further, it is desirable also in view of reduction of the amount of data transmitted/transmission time.

Compression Rate

The compression rate may be changed in a case of performing compression processing on the sound data. That is, the parameter to designate the compression rate in the compression processing is switched between the moving image sound and the sound memo.

Relatively low compression rate is set in the case of the moving image sound where the sound quality is important. On the other hand, relatively high compression rate is set in the case of the sound memo where the data size is desirably made smaller.

Directivity Property

The directivity property can be controlled by using a method such as beam forming, for example, in the signal processing of the sound processing unit 26.

Note that although two microphones that are the microphones 25L and 25R are provided in this embodiment, the provision of three or more microphones makes it easy to control the directivity property.

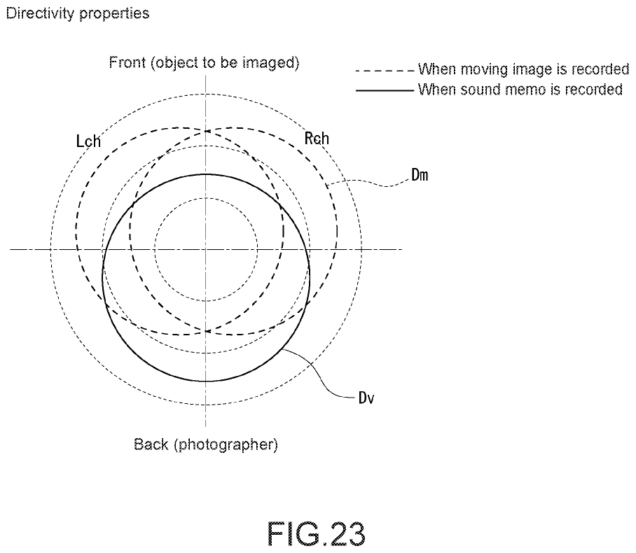

FIG. 23 shows an example of a directivity property Dm at the time of recording the moving image and a directivity property Dv at the time of recording the sound memo.

In the case of the moving image sound, it is desirable to collect mainly sound in the direction of an object being imaged. In view of this, directivity with which the microphone 25L on the L channel side is on the front left side and the microphone 25R on the R channel is on the front right side is set like the directivity property Dm.

In the case of the sound memo, the user who uses the imaging apparatus 1 utters a voice while checking the image on the display unit 15, for example. That is, the sound comes to the imaging apparatus 1 from the back. In view of this, the directivity is provided on the back side like the directivity property Dv.

With such control, sound collection suitable for each of the types of sound is performed.

As described above, various examples of the change of the processing according to the parameter setting of Steps S302 and S303 of FIG. 20 are assumed. Besides, regarding the noise reduction processing, reverberation processing, acoustic effect processing, and the like, for example, changing processing parameters between the moving image sound and the sound memo to change the processing contents is assumed.

Then, in Steps S302 and S303, parameter setting control regarding any one of the above-mentioned parameters may be performed or parameter setting control regarding a plurality of parameters may be performed.

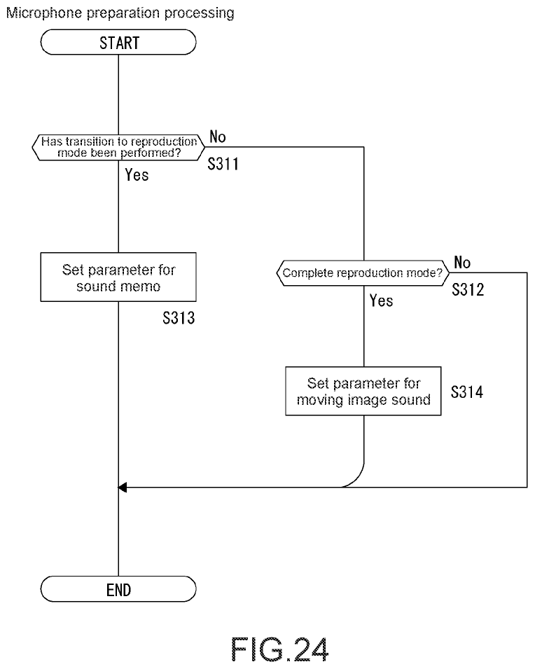

FIG. 24 shows another example of the microphone preparation processing of the camera control unit 18. It is an example in which the camera control unit 18 monitors switching of the operation mode and switches the parameter. Examples of the operation mode can include an imaging mode on which still images and moving images are captured, a reproduction mode on which images are reproduced, a setting mode on which various settings are made. The imaging mode may be divided into a still image-capturing mode and a moving image-capturing mode. Here, it is assumed that record of the sound memo is performed in a case where an operation of the sound memo record is performed in a state in which the user causes a still image to be reproduced and displayed on the reproduction mode.

In Step S311, the camera control unit 18 checks whether or not whether or not a transition to the reproduction mode has been performed as a change of the operation mode based on the user's operation, for example. In Step S312, the camera control unit 18 checks whether or not the reproduction mode has been terminated and a transition to another mode (for example, the imaging mode) has been performed.

In a case where the transition to the reproduction mode has been performed, the camera control unit 18 proceeds from Step S311 to Step S313 and performs parameter setting for the sound memo with respect to the sound processing unit 26.

Further, on the reproduction mode, the camera control unit 18 proceeds from Step S312 to Step S314 and performs parameter setting for the moving image sound with respect to the sound processing unit 26.

On the reproduction mode, the situation where record of the sound data is performed is only the case of recording the sound memo. In view of this, it is assumed that regarding the period of the reproduction mode, the parameter setting for the sound memo is performed with respect to the sound processing unit 26.

Further, on a mode other than the reproduction mode, it is considered that the situation where record of the sound data is performed is only the case of the moving image record. Therefore, it is only necessary to perform parameter setting for the moving image sound with respect to the sound processing unit 26.

By doing so, suitable parameter setting can be prepared in advance before the start of record of the sound data.

When record of the sound data is actually started, the camera control unit 18 performs ON control of the microphones 25L and 25R (powering the microphone amplifier or the like) and causes the microphones 25L and 25R to start supply of the collected sound signals into the sound processing unit 26. At this time, the sound processing based on the parameter setting is executed.

Note that an example in which record of the sound memo is, on the still image-capturing mode, performed in accordance with an operation immediately after the still image is recorded is also assumed.

In that case, the parameter setting for the sound memo may be performed with respect to the sound processing unit 26 on the still image-capturing mode and parameter setting for the moving image sound may be performed with respect to the sound processing unit 26 on the moving image-capturing mode.

### 5. Summery and Modified Examples

In accordance with the above-mentioned embodiment, the following effects can be obtained. The imaging apparatus 1 according to the embodiment includes the sound processing unit 26 that performs processing with respect to the sound signals input through the microphones 25L and 25R and the camera control unit 18 that separately controls the parameter related to the processing of the sound signal at the time of recording the captured image when the sound data processed by the sound processing unit 26 is recorded together with the image data obtained by imaging through the imaging unit 12 and at the time of recording the sound memo when the sound data processed by the sound processing unit 26 is recorded as the sound memo. Accordingly, the parameter related to the processing of the sound signal is set to be different at the time of recording the captured image and the time of recording the sound memo. At the time of recording the moving image, a surrounding sound is collected through the microphones 25L and 25R and recorded as the sound data in synchronization with the moving image to be captured. Therefore, it is desirable to obtain various surrounding sounds as sound belonging to the moving image with suitable sound quality and sound volume. By the way, at the time of recording the sound memo, it is only necessary to clearly record a voice uttered by the user. That is, the property necessary for the sound data is different.

In view of this, by setting the sound processing parameters different at the time of recording the moving image and the time of recording the sound memo, the sound processing can be controlled to obtain sound data suitable for each of the moving image and the sound memo.

Further, accordingly, the microphones 25L and 25R can be suitably commonly used for record of the moving image sound and record of the sound memo. For example, it is unnecessary to additionally provide a dedicated microphone for the sound memo. Therefore, the imaging apparatus 1 can provide advantages of facilitation of arrangement of components in the casing and reduction of the manufacturing cost.

Note that by separately controlling the parameter related to the processing of the sound signal at the time of recording the captured image and the time of recording the sound memo, Although it can be assumed that the parameters are different as in the above-mentioned example as a result, the same parameters may be provided as a result of separate control. As a matter of course, the camera control unit 18 may perform control such that the parameter related to the processing of the sound signal is different at the time of recording the moving image and the time of recording the sound memo and a different parameter setting corresponding to each of the moving image and the sound memo is performed.

Further, although the time of recording the moving image and the time of recording the sound memo have been described in the embodiment, a surrounding sound for a predetermined time (for example, several seconds) during the still image record may be collected and may be recorded as sound corresponding to the still image. In such a case, the parameters of the sound processing may be similar to those at the time of recording the moving image.

In the embodiment, the example in which when starting record of the sound data, the camera control unit 18 performs switching control of the parameter in a manner that depends on whether record of the sound data to be started is sound record at the time of recording the captured image (for example, at the time of recording the moving image) or sound record at the time of recording the sound memo has been described (see FIG. 20).

Accordingly, the parameter of the sound processing unit 26 can be set to be a parameter suitable for the purpose for recording the sound data at a necessary timing.

In the embodiment, the example in which the camera control unit 18 performs switching control of the above-mentioned parameter in accordance with switching of the operation mode also has been described (see FIG. 24).

Accordingly, the parameter of the sound processing unit 26 can be set to be a parameter suitable for the purpose of recording the sound data at a necessary timing. For example, in a case where the sound memo record is executed on the reproduction mode, the parameter setting may be changed for the sound memo when the reproduction mode is turned on. Further, it is only necessary to change the parameter setting for the moving image sound when a moving image-recording mode is turned on. By switching the parameter in accordance with the mode transition, advantages such as alleviation of the processing load at the start of actual sound data record and prevention of delay of the start of the sound processing along with a change in the parameter setting can be obtained.

In the embodiment, the example in which a parameter to perform setting related to the gain processing in the sound processing unit 26 is switched at the time of recording the sound memo and the time of recording the moving image has been shown. For example, the parameter is a parameter to set the AGC property of the sound processing unit, a parameter to designate a fixed input gain, or the like.

Accordingly, AGC processing or input gain processing suitable for each of the moving image sound and the sound memo is performed. For example, for the sound of the sound memo, a wide dynamic range is unnecessary, and it is better to compress sound to a certain degree. By the way, the moving image sound becomes desirable sound with a wider dynamic range because it enhances the sense of presence. Suitable AGC processing is performed in accordance with those circumstances.

In the embodiment, the example in which the parameter to set a frequency property given to the sound data by the sound processing unit 26 is switched at the time of recording the sound memo and the time of recording the moving image has been shown.

For example, in a case where the sound processing unit 26 performs the filtering processing or equalizing processing, it is a parameter to set the frequency property.

Accordingly, the sound data of the frequency property suitable for each of the moving image sound and the sound memo is obtained. For example, the moving image sound includes various sounds such as human voices and surrounding environment sounds and a wide frequency property is desirable. On the other hand, the sound memo has a purpose for collecting sound of only human voices, and thus it is only necessary to provide a band with which human voices can be clearly heard. By switching the parameter to set the frequency property in accordance with those situation, the sound data having the frequency property suitable for each of the moving image sound and the sound memo can be obtained.

In the embodiment, the example in which the parameter to set the directivity of the microphones 25L and 25R is switched at the time of recording the sound memo and the time of recording the moving image has been shown.

Accordingly, a sound can be collected by the microphones given the directivity suitable for each of the moving image sound and the sound memo. For example, for the moving image sound, it is desirable that the microphones 25L and 25R respectively have relatively wide directivity on the left and right for widely collecting surrounding environment sounds and collecting stereo sounds. On the other hand, for the sound memo, it is desirable to provide directivity with which sounds on the back side of the imaging apparatus 1 can be collected for collecting sounds of the user who possesses the imaging apparatus 1. Therefore, desirable sound collection can be achieved by switching the directivity in a manner that depends on whether it is the time of recording the moving image or the time of recording the sound memo.

In the embodiment, the example in which the parameter related to the processing to make a change in the amount of data of the sound data in the sound processing unit 26 is switched at the time of recording the sound memo and the time of recording the moving image.

Possible examples of the parameter related to the processing to make a change in the amount of data of the sound data can include a parameter to set the sampling frequency, a parameter to designate the compression rate, a parameter to designate the number of channels, and a parameter to designate the number of quantization bits.

For example, for the sound data of the moving image sound, it is desirable to enhance the sound quality rather than reducing the amount of data as compared to the sound memo. Therefore, it is processed as two-channel stereo sound data by increasing the sampling frequency or lowering the compression rate. On the other hand, for the sound memo, it is unnecessary to provide a high sound quality because the contents are understandable and it is instead desirable to reduce the amount of data in view of storage or upload. In view of this, processing to generate monophonic data or the like is performed by lowering the sampling frequency or increasing the compression rate. Accordingly, the sound data according to the situation of the moving image sound or the sound memo can be obtained.

Note that possible examples of the parameter which is changed at the time of recording the captured image and the time of recording the sound memo can include various parameters other than the parameters to change the AGC property, the frequency property, the directivity, and the amount of data. For example, a noise cancel processing method or a cancel level may be changed.

In the embodiment, it has been assumed that the sound memo is sound data associated with one piece of still image data.

With such the sound memo, it is possible to easily add explanation or notes for the contents, the object, the scene, or the like related to the one piece of still image data.

In the embodiment, the sound data input through the microphones 25L and 25R and processed by the sound processing unit 26 is used as the sound memo associated with the specified still image data in the state in which the one piece of still image data is specified as described above. The user inputs a sound by performing a predetermined operation with one still image displayed on the reproduction mode, for example. Accordingly, the obtained sound data is recorded as the sound memo. The user only needs to utter a sound while viewing the displayed still image. Thus, the sound memo can be easily and correctly recorded.

It has been assumed that the sound memo according to the embodiment is the sound data associated with the one piece of still image data and is recorded as the sound file other than the image file containing the still image data.

For example, in the state in which the still image data is recorded as the image file PF and the sound data of the sound memo is recorded as the sound file AF, the sound memo is managed in a state in which the sound memo is associated with the still image data.

The sound memo is not metadata added to the still image data, for example, but is contained in the independent sound file. In this manner, the sound file containing the sound memo can be handled independently of the image file containing the still image data. On the other hand, the correspondence relationship is maintained and the sound memo function can be exerted by performing management in association by using the same file name except for the filename extension, for example.

In the imaging apparatus 1 according to the embodiment, the sound data processed by the sound processing unit 26 is recorded as the moving image sound synchronized with the moving image data at the time of recording the captured image, in particular, at the time of recording the moving image.

That is, the microphones 25L and 25R are commonly used for collecting the moving image sound and collecting the sound memo and the sound data suitable for each of the moving image sound and the sound memo is obtained by the parameter setting control.

The imaging apparatus 1 according to the embodiment includes the microphones 25L and 25R. That is, the technology of the present disclosure can be applied in a case where the microphones 25L and 25R incorporated in the imaging apparatus 1 are commonly used for collecting sound of the sound memo and the moving image sound.

It should be noted that the present technology can be applied also in a case where a separate microphone is connected to the imaging apparatus 1 and used. Alternatively, one microphone may be incorporated or connected. Alternatively, the moving image sound and the sound memo may be obtained as monophonic sound data.

In the imaging apparatus 1 according to in the embodiment, sound collection of a plurality of channels (two channels) is performed through the microphones 25L and 25R and the microphone input level is displayed for each channel (see FIG. 9).

The microphone input level (the sound pressure level) of each channel is displayed corresponding to a plurality of channel inputs for stereo input or the like. In this manner, the user can adjust the distance from the microphones or the like to provide suitable sound volume while viewing an indicator displayed in real time during record. In this case, the user can more suitably perform the adjustment because the user can check the sound pressure of each of the left and right microphones. For example, it is easy to adjust the face position when the user utters a voice to be closer to the right or left microphone.

The program according to the embodiment is a program that causes an arithmetic processing apparatus such as the CPU and the DSP of the imaging apparatus 1, for example, to execute the processing as described with reference to FIGS. 20 and 24.

That is, the program according to the embodiment causes the arithmetic processing apparatus to execute the processing of separately controlling the parameter related to the processing of the sound signal at the time of recording the captured image when the sound data processed by the sound processing unit 26 that performs processing related to the sound signal input through the microphones 25L and 25R is recorded together with the image data obtained by imaging through the imaging unit 12 and at the time of recording the sound memo when the sound data processed by the sound processing unit 26 is recorded as the sound memo.

The imaging apparatus 1 according to the present technology can be easily realized by incorporating such a program in the imaging apparatus 1 (the camera control unit 18) as firmware, for example.

Such a program may be recorded in advance on a HDD serving as a recording medium included in equipment such as a computer apparatus, a ROM inside a microcomputer having a CPU, or the like. Alternatively, such a program may be temporarily or permanently stored in (recorded on) a removable recording medium such as a flexible disk, a compact disc read-only memory (CD-ROM), a magneto optical (MO) disc, a digital versatile disc (DVD), a Blu-ray Disc™, a magnetic disc, a semiconductor memory, and a memory card. Such a removable recording medium may be offered as so-called package software.

Further, such a program may be downloaded from a download site via a network such as a local area network (LAN) and the Internet, besides being installed in a personal computer or the like from a removable recording medium.

Note that the effects described in the present specification are given for illustration and not limitative. Further, other effects may be produced.

It should be noted that the present technology can also take configurations as follows.

(1) An imaging apparatus, including:
a sound processing unit that performs processing with respect to a sound signal input through a microphone; and
a control unit that separately controls a parameter related to processing of the sound signal at a time of recording of a captured image when sound data processed by the sound processing unit is recorded together with image data obtained by imaging through an imaging unit and a time of recording a sound memo when the sound data processed by the sound processing unit is recorded as the sound memo.

(2) The imaging apparatus according to (1), in which
the control unit performs control such that the parameter related to the processing of the sound signal is different at the time of recording the captured image and the time of recording the sound memo.

(3) The imaging apparatus according to (1) or (2), in which
the control unit performs switching control of the parameter in a manner that depends on whether record of the sound data to be started is sound record at the time of recording the captured image or sound record at the time of recording the sound memo when starting record of the sound data.

(4) The imaging apparatus according to any one of (1) to (3), in which
the control unit performs switching control of the parameter in a manner that depends on switching of an operation mode.

(5) The imaging apparatus according to any one of (1) to (4), in which
the parameter includes a parameter to perform setting related to gain processing at the sound processing unit.

(6) The imaging apparatus according to any one of (1) to (5), in which
the parameter includes a parameter to set a frequency property given to the sound data by the sound processing unit.

(7) The imaging apparatus according to any one of (1) to (6), in which
the parameter includes a parameter to set directivity of the microphone.

(8) The imaging apparatus according to any one of (1) to (7), in which
the parameter includes a parameter related to processing to make a change in the amount of data of the sound data.

(9) The imaging apparatus according to any one of (1) to (8), in which
the sound memo includes sound data associated with one piece of still image data.

(10) The imaging apparatus according to any one of (1) to (9), in which
the sound data input through the microphone and processed by the sound processing unit in a state in which one piece of still image data is specified is used as the sound memo associated with the specified still image data.

(11) The imaging apparatus according to any one of (1) to (10), in which
the sound memo includes sound data associated with one piece of still image data and is recorded in a sound file different from an image file containing the still image data.

(12) The imaging apparatus according to any one of (1) to (11), in which
the time of recording the captured image is the time of recording a moving image, and
the sound data processed by the sound processing unit is recorded as a moving image sound synchronized with moving image data.

(13) The imaging apparatus according to any one of (1) to (12), further including the microphone.

(14) The imaging apparatus according to any one of (1) to (13), in which
sound collection of a plurality of channels is performed through the microphone, and display of a microphone input level is performed for each channel.

(15) The imaging apparatus according to any one of (1) to (14), in which
the microphone includes a microphone to be used in sound collection for obtaining the sound data both at the time of recording the captured image and the time of recording the sound memo.

(16) A sound processing method, including
separately controlling a parameter related to processing of a sound signal at a time of recording a captured image when sound data processed by a sound processing unit that performs processing with respect to the sound signal input through a microphone is recorded together with image data obtained by imaging through an imaging unit and a time of recording a sound memo when the sound data processed by the sound processing unit is recorded as the sound memo.

(17) A program that causes an arithmetic processing apparatus to execute
processing to separately control a parameter related to processing of a sound signal at a time of recording a captured image when sound data processed by a sound processing unit that performs processing with respect to the sound signal input through a microphone is recorded together with image data obtained by imaging through an imaging unit and a time of recording a sound memo when the sound data processed by the sound processing unit is recorded as the sound memo.

### REFERENCE SIGNS LIST

1 Imaging apparatus
11 Lens system
12 Imaging unit
13 Camera signal processing unit
14 Record control unit
15 Display unit
16 Communication unit
17 Operation unit
18 Camera control unit
19 Memory unit
22 Driver unit
23 Sensor section
25 Sound input unit
25L, 25R Microphone
26 Sound processing unit

1. An imaging apparatus, comprising:
a sound processing unit that performs processing with respect to a sound signal input through a microphone; and
a control unit that separately controls a parameter related to processing of the sound signal at a time of recording of a captured image when sound data processed by the sound processing unit is recorded together with image data obtained by imaging through an imaging unit and a time of recording a sound memo when the sound data processed by the sound processing unit is recorded as the sound memo.

2. The imaging apparatus according to claim 1, wherein
the control unit performs control such that the parameter related to the processing of the sound signal is different at the time of recording the captured image and the time of recording the sound memo.

3. The imaging apparatus according to claim 1, wherein
the control unit performs switching control of the parameter in a manner that depends on whether record of the sound data to be started is sound record at the time of recording the captured image or sound record at the time of recording the sound memo when starting record of the sound data.

4. The imaging apparatus according to claim 1, wherein
the control unit performs switching control of the parameter in a manner that depends on switching of an operation mode.

5. The imaging apparatus according to claim 1, wherein
the parameter includes a parameter to perform setting related to gain processing at the sound processing unit.

6. The imaging apparatus according to claim 1, wherein
the parameter includes a parameter to set a frequency property given to the sound data by the sound processing unit.

7. The imaging apparatus according to claim 1, wherein
the parameter includes a parameter to set directivity of the microphone.

8. The imaging apparatus according to claim 1, wherein
the parameter includes a parameter related to processing to make a change in the amount of data of the sound data.

9. The imaging apparatus according to claim 1, wherein
the sound memo comprises sound data associated with one piece of still image data.

10. The imaging apparatus according to claim 1, wherein
the sound data input through the microphone and processed by the sound processing unit in a state in which one piece of still image data is specified is used as the sound memo associated with the specified still image data.

11. The imaging apparatus according to claim 1, wherein
the sound memo comprises sound data associated with one piece of still image data and is recorded in a sound file different from an image file containing the still image data.

12. The imaging apparatus according to claim 1, wherein
the time of recording the captured image is the time of recording a moving image, and
the sound data processed by the sound processing unit is recorded as a moving image sound synchronized with moving image data.

13. The imaging apparatus according to claim 1, further comprising the microphone.

14. The imaging apparatus according to claim 1, wherein
sound collection of a plurality of channels is performed through the microphone, and
display of a microphone input level is performed for each channel.

15. The imaging apparatus according to claim 1, wherein
the microphone comprises a microphone to be used in sound collection for obtaining the sound data both at the time of recording the captured image and the time of recording the sound memo.

16. A sound processing method, comprising
separately controlling a parameter related to processing of a sound signal at a time of recording a captured image when sound data processed by a sound processing unit that performs processing with respect to the sound signal input through a microphone is recorded together with image data obtained by imaging through an imaging unit and a time of recording a sound memo when the sound data processed by the sound processing unit is recorded as the sound memo.

17. A program that causes an arithmetic processing apparatus to execute
processing to separately control a parameter related to processing of a sound signal at a time of recording a captured image when sound data processed by a sound processing unit that performs processing with respect to the sound signal input through a microphone is recorded together with image data obtained by imaging through an imaging unit and a time of recording a sound memo when the sound data processed by the sound processing unit is recorded as the sound memo.
